(19) United States
(12) Patent Application Publication
(10) Pub. No.: US 2016/0360743 A1
(43) Pub. Date: Dec. 15, 2016

(54) 360-DEGREE TREE STAND

(71) Applicants: William Gregory, Auburn, KY (US); Jason Harper, Auburn, KY (US)

(72) Inventors: William Gregory, Auburn, KY (US); Jason Harper, Auburn, KY (US)

(21) Appl. No.: 14/739,148

(22) Filed: Jun. 15, 2015

(51) Int. Cl. A01M 31/02; E06C 1/00

(52) U.S. Cl. CPC A01M 31/02; E06C 1/005

(57) ABSTRACT

A hunting platform that includes a first side and a second side, where the first side includes a plurality of contacting grips on an inner perimeter of the first side and likewise the second side includes a plurality of contacting grips on an inner perimeter of the first side. The second side joins with the first side around a tree trunk to form the platform. A first ladder leads up to the platform, where the first ladder is positioned between a first opening between the first side and second side. A second ladder leads up to the platform, where the second ladder is positioned between a second opening between the first side and second side.

### BACKGROUND OF THE INVENTION

Field of Invention

The present invention relates to a hunting tree stand that is used for hunters to have an elevated position while hunting various game.

Description of Related Art

Tree stands provide platforms that are used to elevate the hunter while hunting various game. Some hunting stands are standalone in a tripod type of arrangement. Typically, the tree stand is secured or attached to a tree in the wilderness. The tree stand typically includes a standing platform and a ladder that provides access to the tree stand. The tree stand is usually wrapped to the tree with cable or metal and is secured through the use of various attachment devices. Once in place a hunter may sit or stand in this elevated position to have a better vantage point of any approaching game. One drawback of the use of the traditional tree stand is that the position of the stand may restrict the hunter's ability of taking a shot at prey. Typically the tree stand is placed on one side of the tree trunk and as a consequence the tree trunk may become an obstruction to a clean shot on prey. Therefore it would be advantageous to have a tree stand that is capable of wrapping around the entire trunk of a tree.

### SUMMARY OF THE INVENTION

The present invention relates to a hunting platform that includes a first side and a second side. The first side includes a plurality of contacting grips on an inner perimeter of the first side and likewise the second side includes a plurality of contacting grips on an inner perimeter of the first side. The second side joins with the first side around a tree trunk to form the platform. A first ladder leads up to the platform, where the first ladder is positioned between a first opening between the first side and second side. A second ladder leads up to the platform, where the second ladder is positioned between a second opening between the first side and second side. The first side may include three sides on an outer perimeter of the first side and the second side may also include three sides on an outer perimeter of the second side. In one particular embodiment, the platform floor formed by the first side and the second side is made of mesh metal.

### BRIEF DESCRIPTION OF DRAWINGS

FIG. 1 depicts an overview of a 360-degree tree stand in accordance with the present invention.

### DETAILED DESCRIPTION

The present invention relates to a 360-degree tree stand that is mountable around the entire circumference of a tree trunk. The tree stand is hexagon-shaped and is up to 18 feet in height with a ladder incorporated within the tree stand. The stand wraps around the trunk of the tree and provides the hunter with the ability to maneuver around the perimeter of the tree stand to have vision and angles for shots upon prey. The platform of the present invention is preferably made of a mesh metal flooring to provide lightweight and sturdy performance. Aluminum tubing may also be used to support the mesh metal floor. Grips are provided on the inner abutting surface of the mesh platform.

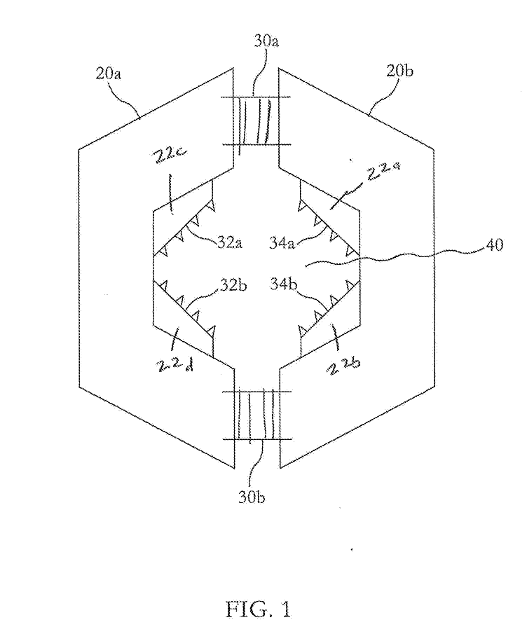

In reference to FIG. 1, a two-sided tree stand in accordance with the present invention is depicted. The tree stand in accordance with the present invention includes a first side 20a and a second side 20b. Ladders 30a, 30b are provided between the two sides of the tree stand in accordance with the present invention. The ladders 30a, 30b provide access to the tree stand's platform through two openings provided on opposing sides of the tree stand. An Opening 40 is provided and shown in FIG. 1. This opening 40 is filled with a tree trunk during use of the tree stand. The inner surface of each respective side of the tree stand platform is provided with contacting grips 32a, 32b for the first side 20a and grips 34a, 34b for the second side of the Platform 20b. These grips provide for a firm adherence of the tree stand to the outer surface of a tree trunk. Once in place a user may access the platform of the tree stand by using either ladder 30a, 30b, where the platform is formed by the first side 20a and second side 20b. This configuration therefore enables the implementation of a 360-degree tree stand for use by a hunter. Preferably the tree stand is hexagon shape is shown where three sides are provided for each respective side of the tree stand. The instant invention has been shown and described in what it considers to be the most practical and preferred embodiments. It is recognized, however, that departures may be made there from within the scope of the invention and that obvious modifications will occur to a person skilled in the art.

1. A hunting platform comprising:
a. a first side, where the first side includes a first set of contacting grips and a second set of contacting grips on an inner perimeter of the first side, where the first set of contacting grips on a first inner edge and said first inner edge is at a first angle, and the second set of contacting grips on a second inner edge and said second inner edge is at a second angle;
b. a second side, where the second side includes a third set of contacting grips and a fourth set of contacting grips on an inner perimeter of the first second side and the second side joins with the first side around a tree trunk, where the third set of contacting grips on a third inner edge and said third inner edge is at a third angle, and the fourth set of contacting grips on a fourth inner edge and said fourth inner edge is at a fourth angle;
c. a first ladder leading up to the platform, where the first ladder is positioned in a first opening between the first side and the second side; and
d. a second ladder leading up to the platform, where the second ladder is positioned between a second opening between the first side and the second side.

2. The hunting platform according to claim 1, where the first side includes a first outer perimeter, where the outer perimeter includes three adjacent sides.

3. The hunting platform according to claim 2, where the second side includes a second outer perimeter, where the outer perimeter includes three adjacent sides.

4. The hunting platform according to claim 1, where further including a platform floor formed by the first side and the second side.

5. The hunting platform according to claim 4, where the platform floor is made of mesh metal.
